(19) United States
(12) Patent Application Publication
(10) Pub. No.: US 2025/0297963 A1
(43) Pub. Date: Sep. 25, 2025

(54) OPTICAL APPARATUS, OPTICAL INSPECTION SYSTEM, OBJECT IMAGING METHOD, AND NON-TRANSITORY STORAGE MEDIUM STORING OBJECT IMAGING PROGRAM

(71) Applicant: KABUSHIKI KAISHA TOSHIBA, Tokyo (JP)

(72) Inventors: Hiroshi OHNO, Tokyo (JP); Kenta TAKANASHI, Kawasaki Kanagawa (JP)

(73) Assignee: KABUSHIKI KAISHA TOSHIBA, Tokyo (JP)

(21) Appl. No.: 19/061,642

(22) Filed: Feb. 24, 2025

(30) Foreign Application Priority Data
Mar. 19, 2024 (JP) 2024-043815

(51) Int. Cl. G01N 21/88

(52) U.S. Cl. CPC G01N 21/8806; G01N 21/8851; G01N 2021/8845; G01N 2201/0635; G01N 2201/104; G01N 2201/1087

(57) ABSTRACT

According to an embodiment, an optical apparatus includes: an illumination portion, a light receiving portion, and a processor. The illumination portion is configured to illuminate an object with light. The illumination portion is configured to illuminate a first illumination point of the object with light having a first wavelength and illuminate a second illumination point different from the first illumination point of the object with light having a second wavelength. The light receiving portion is configured to move relative to the object while maintaining a positional relationship with the illumination portion and is configured to receive light that passed through the first illumination point of the object and light that passed through the second illumination point. The processor is configured to image the object by light reception signals of the light that passed through the first illumination point and the second illumination point.

### CROSS-REFERENCE TO RELATED APPLICATIONS

This application is based upon and claims the benefit of priority from Japanese Patent Application No. 2024-043815, filed Mar. 19, 2024, the entire contents of all of which are incorporated herein by reference.

### FIELD

Embodiments described herein relate generally to an optical apparatus, an optical inspection system, an object imaging method, and a non-transitory storage medium storing an object imaging program.

### BACKGROUND

In various industries, contactless imaging (image capturing) technology for imaging an object being conveyed is important. In a conventional method, there is a method for irradiating an object with illumination and imaging (capturing an image of) the object with a camera. However, imaging with a camera has a problem that, if imaging is performed obliquely with respect to a planar subject, a portion that is out of focus is present, that is, a portion that cannot be imaged is present.

### BRIEF DESCRIPTION OF THE DRAWINGS

FIG. 1 is a schematic perspective view of an optical inspection system according to a first embodiment.

FIG. 2 is a schematic block diagram of the optical inspection system according to the embodiment.

FIG. 3 is a flowchart illustrating an example of a processing procedure in the optical inspection system according to the embodiment.

FIG. 4 is a view illustrating an example of an illumination portion of an optical apparatus according to a modification of the first embodiment.

FIG. 5 is a schematic perspective view of an optical inspection system according to a second embodiment.

FIG. 6 is a schematic perspective view of an optical inspection system according to Modification 1 of the second embodiment.

FIG. 7 is a schematic cross-sectional view of an optical inspection system according to Modification 2 of the second embodiment.

FIG. 8 is a schematic perspective view of an optical inspection system according to a third embodiment.

FIG. 9 is a schematic top view illustrating a first wavelength and a second wavelength from a light source of an illumination portion of the optical inspection system according to the third embodiment, and an object conveyed on a conveyance portion of a conveyance apparatus.

FIG. 10 is a schematic top view illustrating the first wavelength and the second wavelength from the light source of the illumination portion of the optical inspection system and the object conveyed on the conveyance portion of the conveyance apparatus after an appropriate time elapsed from time illustrated in FIG. 9.

FIG. 11 is a schematic perspective view of an optical inspection system according to a modification of the third embodiment.

### DETAILED DESCRIPTION

Hereinafter, each embodiment will be described with reference to the drawings. The drawings are schematic or conceptual, and a relationship between a thickness and a width of each portion, a ratio of sizes of portions, and the like are not necessarily the same as actual ones. In addition, even in the case of representing the same portion, dimensions and ratios may be represented differently from each other depending on the drawings. In the present specification and each drawing, the same elements as those described in relation to already described drawings are denoted by the same reference numerals, and the detailed description thereof is appropriately omitted.

In the present specification, it is assumed that light is a type of electromagnetic wave, and includes an X-ray, an ultraviolet ray, visible light, an infrared ray, a microwave, and the like. In the present embodiment, it is assumed that light is visible light, and for example, a wavelength of the light is in a region of 400 nm to 800 nm.

It is an object of an embodiment is to provide an optical apparatus, an optical inspection system, an object imaging method, and a non-transitory storage medium storing an object imaging program, which are configure to image a relatively moving object not only from a facing position but also obliquely.

According to the embodiment, an optical apparatus includes: an illumination portion, a light receiving portion, and a processor. The illumination portion is configured to illuminate an object relatively moving in a predetermined direction with light. The illumination portion is configured to illuminate a first illumination point of the object with light having a first wavelength and illuminate a second illumination point different from the first illumination point of the object with light having a second wavelength different from the first wavelength. A line segment connecting the first illumination point and the second illumination point intersects the predetermined direction. The light receiving portion includes a first light receiving element that is configured to move relative to the object while maintaining a positional relationship with the illumination portion and that is configured to receive light that passed through the first illumination point of the object and light that passed through the second illumination point. The first light receiving element is configured to distinctively and independently receive the first wavelength and the second wavelength. The processor is configured to image the object by a light reception signal of the light that passed through the first illumination point and a light reception signal of the light that passed through the second illumination point.

### First Embodiment

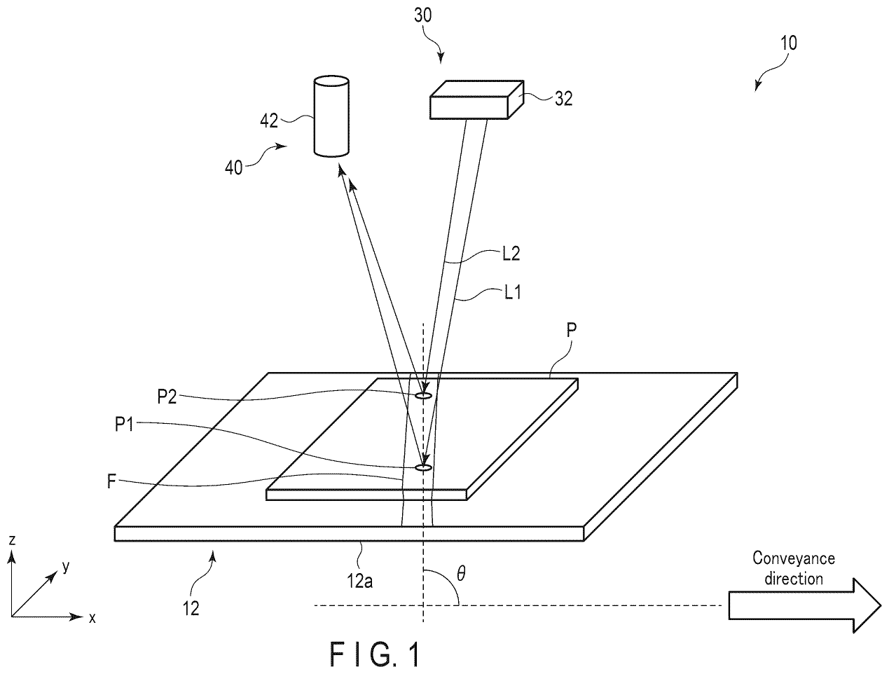

An optical inspection apparatus 10 according to the present embodiment will be described below with reference to FIGS. 1 to 3.

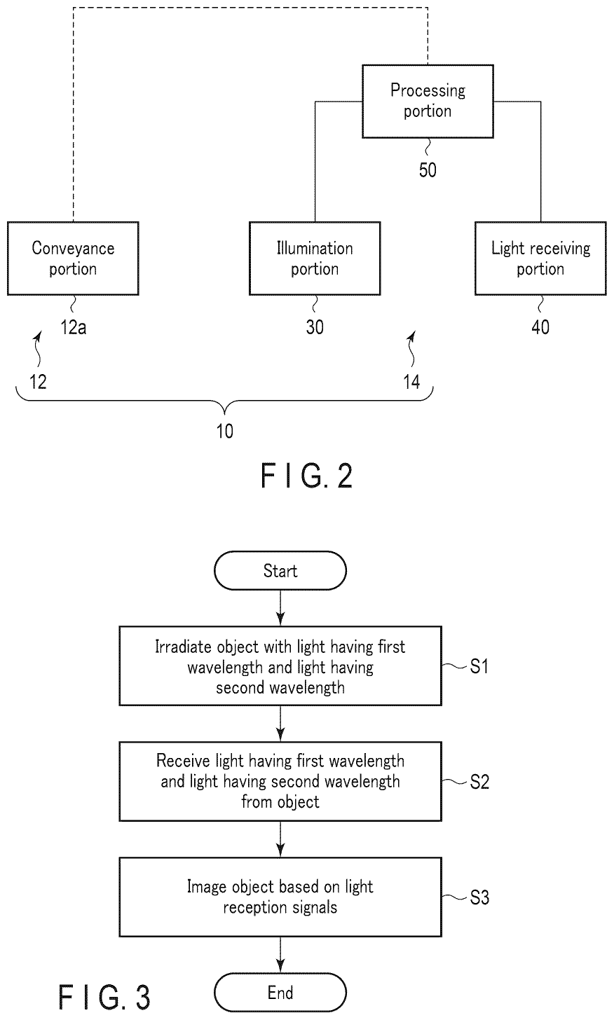

FIG. 1 is a schematic perspective view of the optical inspection system 10 according to the present embodiment. FIG. 2 is a schematic block diagram of the optical inspection system 10 according to the present embodiment. FIG. 3 illustrates a flowchart of optical inspection according to an optical inspection program of the optical inspection system 10 according to the present embodiment.

As illustrated in FIGS. 1 and 2, the optical inspection system 10 according to the present embodiment includes a conveyance apparatus 12 that conveys an object P in a predetermined direction, and an optical apparatus 14 that is used together with the conveyance apparatus 12. An xyz orthogonal coordinate system is taken as illustrated in FIG. 1. It is assumed that a direction along the x-axis is defined as a conveyance direction of the object P by the conveyance portion 12a to be described later. It is assumed that a direction along the y axis is a direction orthogonal to the conveyance direction of the object P. The xy plane is preferably a plane parallel to a floor surface, but is not limited thereto. It is assumed that a direction along the z axis is a direction orthogonal to the xy plane. The direction along the z axis is preferably the vertical direction, but is not limited thereto depending on the position of the xy plane.

The conveyance apparatus 12 is configured to convey the object P on the conveyance portion 12a in the predetermined direction by the conveyance portion 12a. In the present embodiment, the conveyance direction may be any direction, but it is assumed that the x-axis in FIG. 1 is the conveyance direction. However, the conveyance apparatus 12 may move a light receiving portion 40 and an illumination portion 30 of the optical apparatus 14 relative to the object P. The light receiving portion 40 and the illumination portion 30 will be described later. That is, in the optical inspection system 10, the conveyance apparatus 12 may be any apparatus as long as the apparatus changes a relative positional relationship of the object P with respect to the light receiving portion 40 and the illumination portion 30 while maintaining a positional relationship between the light receiving portion 40 and the illumination portion 30. These are collectively referred to as conveyance means of the optical inspection system 10.

Note that the conveyance portion 12a of the conveyance apparatus 12 may be of any type such as a belt conveyor type, a linear motor type, a torque screw (ball screw) type, a parallel link type, a roller conveyor type, an air conveyor type, or a chain conveyor type.

In the present embodiment, for simplicity of explanation, it is assumed that the conveyance apparatus 12 conveys the object P in the straight conveyance direction along the x-axis by the conveyance portion 12a.

The optical apparatus 14 includes the illumination portion 30 that is configured to illuminate the object P relatively moving in the predetermined direction with light, the light receiving portion 40 that is configured to receive reflected light from the object P, and a processing portion 50.

The illumination portion 30 includes a light source 32. The light source (illumination) 32 of the illumination portion 30 is configured to emit light (or light beams) having a first wavelength L1 and a second wavelength L2. Hereinafter, the light having the first wavelength L1 may be simply abbreviated as the first wavelength L1. Similarly, the light having the second wavelength L2 may be simply abbreviated as the second wavelength L2. It is assumed that a point at which the first wavelength L1 reaches the object P is a first illumination point P1, and that a point at which the second wavelength L2 reaches the object P is a second illumination point P2. The illumination portion 30 includes a white light source 32 such as a white light-emitting diode (LED), a halogen lamp, a fluorescent lamp, an incandescent lamp, a high-intensity discharge lamp (HID lamp), or a metal halide lamp. However, the light source 32 is not limited thereto, and a plurality of monochromatic lasers of various colors may be arranged. In a case where the light source 32 is a white light source, the illumination portion 30 may separate light from the white light source 32 into light having the first wavelength and light having the second wavelength using a prism or a diffraction grating (grating). Alternatively, the illumination portion 30 may project light having the first wavelength L1 and the second wavelength L2 onto the object P by a projection apparatus such as a color projector.

The light receiving portion 40 includes a first light receiving element 42. The first light receiving element 42 is configured to receive the light having the first wavelength L1 and the light having the second wavelength L2 and is configured to identify (distinguish) the light having the first wavelength L1 and the light having the second wavelength L2. That is, the first light receiving element 42 can separate the light having the first wavelength L1 and the second wavelength L2. However, it is assumed that the number of light receiving openings of the first light receiving element 42 is one. The light receiving element may be referred to as a single pixel (one pixel) light receiving element. As the first light receiving element 42, for example, a photodiode (PD) or a photomultiplier tube is used. The first light receiving element 42 may be, for example, a dispersive spectrometer in which a prism or a diffraction grating (grating) and a photodiode are combined. Alternatively, a spectrometer using light interference may be used. For example, a spectrometer using a Michelson interferometer or a Fabry-Perot interferometer may be used. Alternatively, a spectrometer in which a prism or a diffraction grating and a plurality of photomultipliers are combined may be used. That is, the first light receiving element 42 may be any element as long as the element distinctively receives the light having the first wavelength L1 and the light having the second wavelength L2 and converts the received light into independent light reception signals.

A relative positional relationship (positions, postures, and orientations) between the light source 32 of the illumination portion 30 and the first light receiving element 42 of the light receiving portion 40 is preferably fixed when a series of imaging of the object P is performed.

A line segment connecting the first illumination point P1 and the second illumination point P2 intersects a line (x-axis) along the conveyance direction of the conveyance apparatus 12. That is, the line segment connecting the first illumination point P1 and the second illumination point P2 is not parallel to the line along the conveyance direction of the conveyance apparatus 12. In other words, an angle θ formed by the line segment connecting the two illumination points P1 and P2 and the line along the conveyance direction is greater than 0° and less than 180°.

In the present specification, acquiring information reflecting a reflectance distribution or a transmittance distribution of the object P is referred to as image capturing or imaging.

The processing portion 50 controls the illumination portion 30 and the light receiving portion 40. In addition, the processing portion 50 may control the conveyance apparatus 12.

The processing portion 50 grasps the position of the light source 32 of the illumination portion 30, irradiation directions of the light having the first wavelength and the second wavelength emitted from the light source 32, and three-dimensional relative positional relationships of the illumination portion 30 and the first light receiving element 42 of the light receiving portion 40 with respect to the first light receiving element 42 and the conveyance apparatus 12. That is, the processing portion 50 grasps the relative positions, postures, and orientations of the light source 32 of the illumination portion 30 and the first light receiving element 42 of the light receiving portion 40.

The processing portion 50 is, for example, a computer. The processing portion 50 includes a processor or an integrated circuit (control circuit) including a central processing unit (CPU), an application specific integrated circuit (ASIC), a field programmable gate array (FPGA), or the like, and a storage medium such as a memory. The processor or the integrated circuit provided in the processing portion 50 may be one or a plurality of processors or integrated circuits. The processing portion 50 executes a process by executing a program or the like stored in the storage medium or the like. For example, an example of the program is an imaging program for imaging the object P. The imaging program for imaging the object P is stored in a non-transitory storage medium.

Furthermore, in the processing portion 50, the program executed by the processor may be stored in a computer (server), a server in a cloud environment, or the like connected via a network such as the Internet. In this case, the processing portion 50 downloads the program via the network.

An operation of the optical inspection system 10 according to the embodiment described above will be described with reference to FIG. 3.

In the present embodiment, an example will be described in which relative positions, postures, and orientations of the illumination portion 30 and the light receiving portion 40 are fixed, and the object P is conveyed by the conveyance portion 12a of the conveyance apparatus 12, that is, the object P moves in the predetermined direction. Here, the object P is conveyed by the conveyance portion 12a of the conveyance apparatus 12.

The processing portion 50 operates the light source 32 of the illumination portion 30 to irradiate the object P on the conveyance portion 12a of the conveyance apparatus 12 with light (step S1). A region irradiated with the light L1 and the light L2 from the light source 32 of the illumination portion 30 is referred to as an irradiation field F. The object P conveyed by the conveyance apparatus 12 is illuminated with light from the light source 32 of the illumination portion 30. Light having the first wavelength L1 and the second wavelength L2 is emitted from the light source 32 of the illumination portion 30, and is reflected by or transmitted through the surface of the object P. In the present specification, it is assumed that, in a case where light is reflected by or transmitted through the object P, the light passed through the object P. In the present embodiment, it is assumed that the object P is reflective, and light is reflected by the surface of the object P. However, the present embodiment is not limited thereto, and the object P may be transparent, translucent, or opaque. Points at which the light having the first wavelength L1 and the light having the second wavelength L2 reach the object P are referred to as a first illumination point P1 and a second illumination point P2, respectively. The light source 32 of the illumination portion 30 emits light such that the first illumination point P1 and the second illumination point P2 are different points on the object P.

The processing portion 50 causes the first light receiving element 42 to receive the light that passed through (in the present embodiment, reflected by) the first illumination point P1 and the second illumination point P2 (step S2). However, the processing portion 50 is not limited thereto. After the processing portion 50 operates the light source 32 of the illumination portion 30 to irradiate the object P on the conveyance portion 12a of the conveyance apparatus 12 with light (step S1), the light that passed through (in the present embodiment, reflected by) the first illumination point P1 and the second illumination point P2 may be received by the first light receiving element 42 under control by the illumination portion 30 (step S2). That is, the processing portion 50 may operate only the illumination portion 30. The first light receiving element 42 acquires the light having the first wavelength L1 and the light having the second wavelength L2 as independent light reception signals for each wavelength. The intensities of these light reception signals are indicators representing the magnitude of the reflectance at the first illumination point P1 and the second illumination point P2. That is, as the reflectance at each of the illumination points P1 and P2 is higher, the intensity of the light reception signal increases accordingly. However, in a case where the object P is transmissive, the object P has transmittance instead of reflectance.

The reflectance or the transmittance is an important characteristic of the object P, and acquiring a distribution of the reflectance or the transmittance of the object P or a distribution of an indicator of the reflectance or the transmittance of the object P is referred to as image capturing or imaging. As described above, the processing portion 50 performs imaging on the first illumination point P1 and the second illumination point P2 (step S3). That is, the processing portion 50 images the object P based on the light reception signals in the first light receiving element 42.

Note that the processing portion 50 can continuously image the object P from the upstream end to the downstream end of the object P along the conveyance direction by repeatedly performing the operation from step S1 to step S3 on the object P conveyed by the conveyance portion 12a.

In a case where the first illumination point P1 and the second illumination point P2 are irradiated with light having the same wavelength by the illumination portion 30, for example, in a case where both the first illumination point P1 and the second illumination point P2 are irradiated with light having the first wavelength L1, the illumination points P1 and P2 cannot be identified even if the light reflected by the illumination points P1 and P2 is received by the first light receiving element 42. This is because the first light receiving element 42 can acquire only the sum of the intensities of the light from the first illumination point P1 and the second illumination point P2 as a light reception signal. In this case, the two different illumination points P1 and P2 cannot be imaged simultaneously. On the other hand, in the present embodiment, since the first illumination point P1 and the second illumination point P2 are irradiated with light having different wavelengths, there is an effect that these two illumination points P1 and P2 can be simultaneously imaged.

In addition, in a case where the first light receiving element 42 cannot identify the light having the first wavelength L1 and the light having the second wavelength L2, that is, in a case where the light reception signals of the light L1 and the light L2 cannot be independently acquired, the first illumination point P1 and the second illumination point P2 cannot be identified from the light reception signals. On the other hand, in the present embodiment, since the first wavelength L1 and the second wavelength L2 can be identified by the first light receiving element 42, there is an effect that the processing portion 50 can simultaneously image the two illumination points P1 and P2.

While the object P is conveyed to the conveyance portion 12a of the conveyance apparatus 12, the relative positions of the first illumination point P1 and the second illumination point P2 with respect to the object P change with time. In this case, the first light receiving element 42 independently receives the light reflected from each of the first and second illumination points according to time. As a result, a reflectance distribution of the object P can be acquired along the conveyance direction of the conveyance portion 12a. That is, the processing portion 50 of the optical inspection system 10 can perform imaging while scanning two different lines on the object P with time. On the other hand, a case where the line segment connecting the first illumination point P1 and the second illumination point P2 is parallel to a line along the conveyance direction is considered. In this case, the processing portion 50 performs imaging while scanning one line passing through the first illumination point P1 and the second illumination point P2 with time. That is, the processing portion 50 cannot perform imaging while simultaneously scanning two or more lines. On the other hand, in the present embodiment, the line segment connecting the first illumination point P1 and the second illumination point P2 intersects the line (x-axis) along the conveyance direction. As a result, there is an effect that the processing portion 50 can image the object P while simultaneously scanning not one line but two lines, that is, lines passing through the first illumination point P1 and the second illumination point P2.

According to the present embodiment, the processing portion 50 performs imaging based on the light reception signals in the first light receiving element 42. In this case, the optical apparatus 14 does not need to perform focusing using a lens or the like that is an imaging optical element in order to acquire the light reception signals. That is, there is no need to adjust the focus by using the distance of the light receiving portion 40 or the imaging optical element or the first light receiving element 42 for imaging, and there is an effect of being focus-free. As a result, by using the optical apparatus 14 according to the present embodiment, there is an effect that the object P such as a planar subject can be imaged not only from directly above, that is, from the facing position of the object P, but also obliquely.

In the present embodiment, an example has been described in which the illumination portion 30 of the optical apparatus 14 illuminates the object P with the first wavelength L1 and the second wavelength L2. For example, it is also preferable that an illumination point on the line segment connecting the first illumination point P1 and the second illumination point P2 be irradiated with light having wavelengths L3, L4, . . . different from both the first wavelength L1 and the second wavelength L2, and the light having the wavelengths be separated and acquired by the first light receiving element 42. In this case, the wavelengths L3, L4, . . . of the light with which the line segment connecting the first illumination point P1 and the second illumination point P2 is irradiated are different from each other.

The processing portion 50 repeats the operations from step S1 to step S3 on the object P conveyed by the conveyance portion 12a, and the first light receiving element 42 separates and receives the light having the wavelengths L1, L2, L3, L4, . . . , so that the object P can be continuously imaged from the upstream end to the downstream end of the object P along the conveyance direction.

In the present embodiment, it has been described that the optical apparatus 14 includes the processing portion 50. For example, as long as the processing portion 50 can process the light reception signals of the first light receiving element 42 of the light receiving portion 40, the processing portion 50 may be located at a position far from the optical apparatus 14 regardless of whether the processing portion 50 is located within or outside the country where the optical apparatus 14 is located.

In the optical inspection system 10 according to the present embodiment, an example in which the object P is moved in the predetermined direction using the conveyance portion 12a has been described. For example, the illumination portion 30 and the light receiving portion 40 may be moved while the object P is irradiated with the light having the first wavelength L1 and the second wavelength L2 and the relative positional relationship (positions, postures, and orientations) between the illumination portion 30 and the light receiving portion 40 is maintained in a state where the object P is stationary. Each of the object P, the illumination portion 30, and the light receiving portion 40 may be moved while the object P is irradiated with the light including the first wavelength L1 and the second wavelength L2 and the relative positional relationship (positions, postures, and orientations) between the illumination portion 30 and the light receiving portion 40 is maintained.

As described above, the optical apparatus 14 according to the present embodiment includes the illumination portion 30 that is configured to illuminate an object relatively moving in a predetermined direction with light, the light receiving portion 40, and the processing portion 50. The illumination portion 30 is configured to illuminate the first illumination point P1 of the object P with the light having the first wavelength L1 and illuminating the second illumination point P2 different from the first illumination point P1 of the object P with the light having the second wavelength L2 different from the first wavelength L1. The line segment connecting the first illumination point P1 and the second illumination point P2 intersects the predetermined direction (for example, the conveyance direction). The light receiving portion 40 includes the first light receiving element 42 that moves relative to the object P while maintaining the positional relationship (position, posture, and orientation) with the illumination portion 30 and receives the light that passed through the first illumination point P1 of the object P and the light that passed through the second illumination point P2. The first light receiving element 42 can distinctively and independently receive the first wavelength L1 and the second wavelength L2. The processing portion 50 images the object P based on a light reception signal of the light that passed through the first illumination point P1 and a light reception signal of the light that passed through the second illumination point P2 was received.

A method for imaging the object P includes: illuminating the first illumination point P1 of the object P with the light having the first wavelength L1 from the illumination portion 30 and illuminating the second illumination point P2 different from the first illumination point P1 of the object P with the light having the second wavelength L2 different from the first wavelength L1 from the illumination portion 30 while maintaining the relative position (position, posture, and orientation) of the optical apparatus 14 including the illumination portion 30 and the light receiving portion 40 and moving, in the predetermined direction, the object relative to the illumination portion 30 and the light receiving portion 40; receiving the light that passed through the first illumination point P1 of the object P and the light that passed through the second illumination point P2 by the light receiving portion 40 including the first light receiving element 42 configured to distinctively and independently receive the first wavelength L1 and the second wavelength L2; and imaging the object P based on a light reception signal of the light that passed through the first illumination point P1 and a light reception signal of the light that passed through the second illumination point P2 was received by the light receiving portion 40. Note that the line segment connecting the first illumination point P1 and the second illumination point P2 intersects the predetermined direction (for example, the conveyance direction).

Furthermore, the non-transitory storage medium stores the imaging program for imaging the object P, and the imaging program causes a computer to execute: illuminating the first illumination point P1 of the object P with the light having the first wavelength L1 from the illumination portion 30 and illuminating the second illumination point P2 different from the first illumination point P1 of the object P with the light having the second wavelength L2 different from the first wavelength L1 from the illumination portion 30 while maintaining the relative position of the optical apparatus 14 including the illumination portion 30 and the light receiving portion 40 and moving, in the predetermined direction, the object P relative to the illumination portion 30 and the light receiving portion 40, a line segment connecting the first illumination point P1 and the second illumination point P2 intersecting the predetermined direction; receiving the light that passed through the first illumination point P1 of the object P and the light that passed through the second illumination point P2 by the light receiving portion 40 including the first light receiving element 42 configured to distinctively and independently receive the first wavelength L1 and the second wavelength L2; and imaging the object P based on a light reception signal of the light that passed through the first illumination point P1 and a light reception signal of the light that passed through the second illumination point P2 was received by the light receiving portion 40.

According to the present embodiment, it is possible to provide the optical apparatus 14, the optical inspection system 10, the method for imaging the object P, and the non-transitory storage medium storing the imaging program for imaging the object P, which are configured to image the relatively moving object P not only from a facing position but also obliquely.

### (Modification 1)

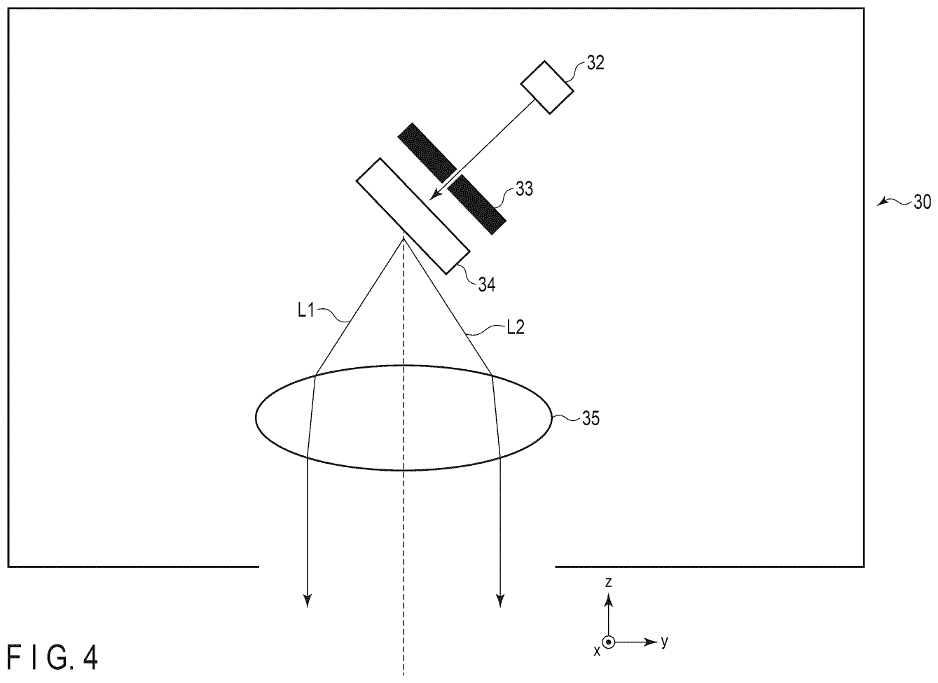

FIG. 4 illustrates an example of an illumination portion 30 of an optical apparatus 14 according to Modification 1 of the optical inspection system 10 according to the present embodiment. FIG. 4 is a cross-sectional view orthogonal to the conveyance direction. An xyz orthogonal coordinate system is taken as illustrated in FIG. 4 following FIG. 1.

The illumination portion 30 includes, for example, a light source 32 such as an LED light source, a diaphragm or an aperture 33, a diffraction grating 34, and an illumination lens 35. The diffraction grating 34 is arranged so as to include a focal point of the illumination lens 35 or the vicinity of the focal point. Light emitted from the light source 32 passes through the diaphragm 33 and reaches the diffraction grating 34. The light that passed through the diaphragm 33 is incident in a direction orthogonal to the diffraction plane of the diffraction grating 34. The light incident on the diffraction grating 34 is transformed into a light beam group in directions different for each wavelength. The light beam group becomes divergent light and reaches the illumination lens 35. Furthermore, the light beam group of the divergent light is transformed into parallel light by the illumination lens 35, and is emitted to the conveyance portion 12a (see FIG. 1) outside the illumination portion 30. As a result, light having different wavelengths reaches the object P at different illumination points. When reaching the object P, the light beam group is parallel light and thus is directed in the same direction at all the illumination points. As a result, for example, the incident directions can be aligned in parallel at the first illumination point P1 irradiated with the light having the first wavelength L1 and the second illumination point P2 irradiated with the light having the second wavelength L2. In addition, in a case where the first light receiving element 42 is sufficiently far from the illumination points P1 and P2, the directions of the reflected light of the light having the first wavelength L1 and the light having the second wavelength L2 can also be aligned. It is known that the reflectance depends on the incident direction and the reflection direction. This direction dependency can be referred to as a bidirectional reflectance distribution function (BRDF). The processing portion 50 can accurately identify a difference between the surface characteristics of the object P by comparing the BRDFs based on the light reception signals in the light receiving portion 40. Here, in order to accurately obtain a surface characteristic distribution on the object P, it is necessary to compare the reflectance while setting the incident direction and the reflection direction of the light from the illumination portion 30 of the optical apparatus 14 to the same direction. That is, the processing portion 50 can accurately compare the BRDFs by aligning the conditions of the two directions (the incident direction and the reflection direction), and can more accurately identify the surface characteristics.

Since the incident directions and the reflection directions can be aligned by the illumination portion 30 of the optical apparatus 14 according to Modification 1 regardless of the position on the object P, there is an effect that the optical inspection system 10 according to Modification 1 can more accurately acquire the surface characteristics of the object P, that is, information of the object P.

### (Modification 2)

Modification 2 is a further modification of the first embodiment and Modification 1. In the first embodiment and Modification 1, an example of using light having the first wavelength L1 and the second wavelength L2 has been described. In the optical apparatus 14 according to the present Modification 2, light having a plurality of (three or more) wavelengths different from each other may be used. That is, for example, light having a wavelength of 450 nm to 750 nm may be dispersed and emitted over the entire irradiation field F intersecting the conveyance direction. In addition, the first light receiving element 42 in the light receiving portion 40 is also configured to separate and receive the plurality of wavelengths simultaneously. This produces an effect of imaging the object P not only at the illumination points P1 and P2 but also over the entire irradiation field F between the illumination points P1 and P2.

For example, by using the diffraction grating 34 illustrated in FIG. 4, the illumination portion 30 can irradiate the surface of the object P with light having a wavelength gradually increased from the first illumination point P1 toward the second illumination point P2 or having a wavelength gradually decreased from the first illumination point P1 toward the second illumination point P2. Therefore, the illumination portion 30 can continuously change the light between the first illumination point P1 and the second illumination point P2 like a rainbow. Therefore, the illumination portion 30 can use the diffraction grating 34 to set the light having the first wavelength L1 and the light having the second wavelength L2 to light at different irradiation positions. The wavelengths between the illumination points P1 and P2 of the irradiation field F can all be different.

The first light receiving element 42 of the light receiving portion 40 may separate and receive not only the two wavelengths L1 and L2 but also wavelengths for every three or more wavelengths. In a case where the first light receiving element 42 of the light receiving portion 40 can separate and receive a larger number of wavelengths, an illumination point corresponding to each wavelength between the first illumination point P1 and the second illumination point P2 can be imaged.

Note that, since the object P is conveyed by the conveyance portion 12a while the relative positional relationship (positions, postures, and orientations) between the illumination portion 30 and the light receiving portion 40 is maintained, the surface of the object P can be imaged while a line passing through each of points between the first illumination point P1 and the second illumination point P2 is simultaneously scanned by using the optical apparatus 14 according to Modification 2.

### (Modification 3)

In the first embodiment and Modifications 1 and 2 described above, the representative points in the region illuminated with the light having the first wavelength L1 and the second wavelength L2 are set as the illumination points, but a region irradiated with the light having the wavelengths L1 and L2 may not be points but a region having a finite spread. That is, the region illuminated with the light having the first wavelength L1 and the second wavelength L2 may have a spread. In this way, in a case where the irradiation field F has a wide spread, imaging can be performed on the object P in a wide band in terms of spatial frequency. That is, the optical apparatus 14 can perform wide and global imaging on the object P. On the other hand, the region illuminated with the light having the first wavelength L1 and the second wavelength L2 may be a region that is narrow enough to be regarded as a point. In this case, the optical apparatus 14 can perform high-resolution imaging on the object P.

Even in a case where regions illuminated with the light having the first wavelength L1 and the second wavelength L2 are wide, the processing portion 50 can perform imaging with high resolution in the conveyance direction by using a difference between signals close in time among a time series of light reception signals received by the light receiving portion 40. That is, the light receiving portion 40 acquires the light reception signals at a high speed, the number of light reception signals that can be acquired per unit time is increased, and the processing portion 50 obtains a difference between the light reception signals and thus can improve the resolution of imaging in the conveyance direction.

### Second Embodiment

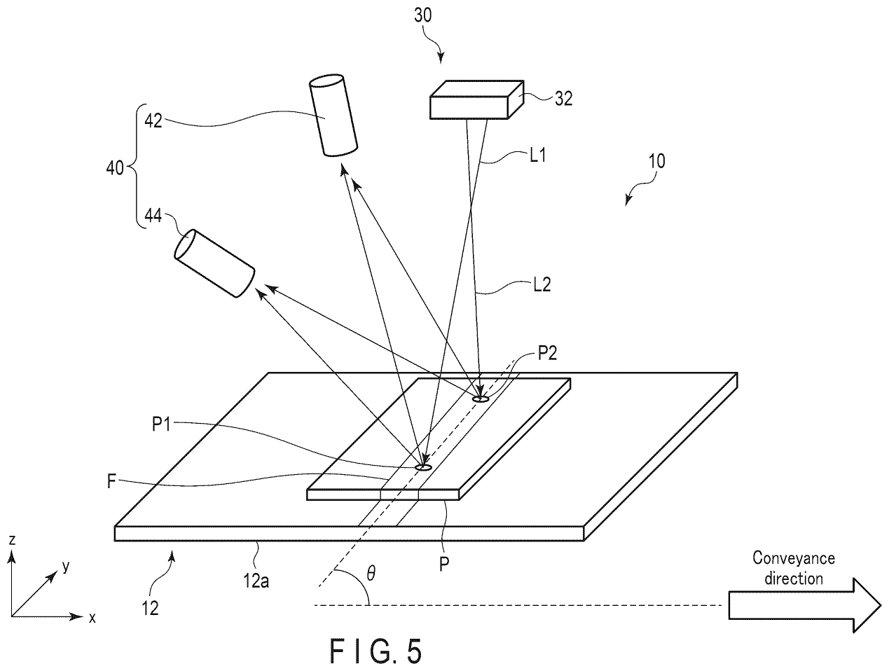

Hereinafter, an optical inspection system 10 according to the present embodiment will be described with reference to FIG. 5. The present embodiment is a further modification of the first embodiment including each modification, and the same members as the members described in the first embodiment or members having the same functions as the members described in the first embodiment are denoted by the same reference numerals as much as possible, and a detailed description thereof will be omitted.

FIG. 5 is a schematic perspective view of the optical inspection system 10 according to the present embodiment. An xyz orthogonal coordinate system is taken as illustrated in FIG. 5 following FIG. 1.

The light receiving portion 40 of the optical apparatus 14 according to the present embodiment includes a first light receiving element 42 and a second light receiving element 44, that is, two light receiving elements 42 and 44. These light receiving elements 42 and 44 are arranged so as to have different spatial positions.

Each of the light receiving elements 42 and 44 can receive light having the first wavelength L1 and light having the second wavelength L2 and can identify the received light having the first wavelength L1 and the second wavelength L2. That is, each of the light receiving elements 42 and 44 can separate the light having the first wavelength L1 and the light having the second wavelength L2. That is, each of the first light receiving element 42 and the second light receiving element 44 may be any element as long as the element distinctively receives the light having the first wavelength L1 and the light having the second wavelength L2, and converts the received light into independent light reception signals.

Similarly to the relationship described in the first embodiment, a line segment connecting a first illumination point P1 of the light having the first wavelength L1 and a second illumination point P2 of the light having the second wavelength L2 by illumination from the illumination portion 30 intersects the line along the conveyance direction of the conveyance portion 12a of the conveyance apparatus 12. That is, the line segment connecting the first illumination point P1 and the second illumination point P2 is not parallel to the line along the conveyance direction of the conveyance portion 12a of the conveyance apparatus 12. In other words, an angle θ formed by the line segment connecting the two illumination points P1 and P2 and the line along the conveyance direction is greater than 0° and less than 180°. In the present embodiment, the angle θ formed by the line segment connecting the two illumination points P1 and P2 and the line along the conveyance direction is orthogonal to each other at 90°. It is assumed that the longitudinal direction of the irradiation field F is along the line (y axis) connecting the two illumination points P1 and P2. As a result, the area where the irradiation field F passes through the object P during the conveyance of the object P can be maximized. On the other hand, as the longitudinal direction of the irradiation field F is aligned with respect to the conveyance direction, the area where the irradiation field F passes through the object P during conveyance becomes is smaller. That is, the region of the irradiation field F passing through the object P can be increased by making the longitudinal direction of the irradiation field F orthogonal to the conveyance direction. In other words, there is an effect that the range that can be imaged using the optical apparatus 14 is increased.

That is, in a case where the distance between the illumination points P1 and P2 is the same, a larger region in the width direction of the conveyance portion 12a can be set as an inspection target by arranging the line segment connecting the illumination points P1 and P2 so as to be orthogonal to the conveyance direction. For example, assuming that the object P is common, in a case where the illumination points P1 and P2 are arranged as illustrated in FIG. 5, a larger range of the object P can be scanned and imaged as compared with a case where the illumination points P1 and P2 are arranged as illustrated in FIG. 1.

An operation of the optical inspection system 10 according to the embodiment described above will be described. Note that, in the present embodiment and also in the following embodiments, the processing portion 50 performs processing according to the procedure illustrated in FIG. 3. In addition, the description of the contents described in the first embodiment will be appropriately omitted. The same applies to the following embodiments.

The light source 32 of the illumination portion 30 emits light toward the conveyance portion 12a of the conveyance apparatus 12. The illumination portion 30 emits light such that the first illumination point P1 and the second illumination point P2 are different points. The light that passed through (in the present embodiment, reflected by) the first illumination point P1 and the second illumination point P2 is received by the first light receiving element 42, and is acquired as independent light reception signals for each wavelength. Similarly, the light that passed through (in the present embodiment, reflected by) the first illumination point P1 and the second illumination point P2 is received by the second light receiving element 44, and is acquired as independent light reception signals for each wavelength.

The intensities of the received light are indicators representing the magnitude of the reflectance at the first illumination point P1 and the second illumination point P2. That is, as the reflectance at each of the illumination points P1 and P2 is higher, the intensity of the received light increases accordingly. However, in a case where the object P is transmissive, the object P has transmittance instead of reflectance. The reflectance or the transmittance is an important characteristic of the object P, and acquiring a distribution of the reflectance or the transmittance of the object P or a distribution of an indicator of the reflectance or the transmittance of the object P is referred to as image capturing or imaging. As described above, imaging can be performed on the first illumination point P1 and the second illumination point P2.

In the present embodiment, the longitudinal direction of the irradiation field F is along the line connecting the two illumination points P1 and P2. As a result, the area where the irradiation field F passes through the object P during conveyance can be maximized. On the other hand, as the longitudinal direction of the irradiation field F is aligned with respect to the conveyance direction, the area where the irradiation field F passes through the object P during conveyance becomes is smaller. That is, as in the optical inspection system 10 according to the present embodiment, the irradiation field F passing through the object P can be increased by making the irradiation field F and the conveyance direction orthogonal to each other. As a result, there is an effect that the range in which the processing portion 50 of the optical apparatus 14 can perform imaging is increased.

In the optical apparatus 14 according to the present embodiment, the first light receiving element 42 and the second light receiving element 44 can receive light in two different reflection directions from the first illumination point P1. Similarly, the first light receiving element 42 and the second light receiving element 44 can receive light in two different reflection directions from the second illumination point P2. Then, in the optical apparatus 14, a relative positional relationship (positions, postures, and orientations) between the illumination portion 30 and the first light receiving element 42 and the second light receiving element 44 of the light receiving portion 40 is grasped. It is known that the BRDF from each point (e.g., the first illumination point P1 and the second illumination point P2) of the object P reflects physical property information of the object P. Then, the processing portion 50 can acquire more detailed physical property information by acquiring reflection angle dependence of the BRDFs. In the present embodiment, the dependence of the BRDF on two different reflection angles can be obtained at the first illumination point P1. Similarly, the dependence of the BRDF on two different reflection angles can be obtained at the second illumination point P2. By using the optical apparatus 14, there is an effect that more detailed physical property information of the object P can be acquired.

For example, it is assumed that the first illumination point P1 is a glossy surface and the second illumination point P2 is a rough surface. That is, reflection with a narrow angular distribution occurs at the first illumination point P1, and reflection with a wide angular distribution occurs at the second illumination point P2. In this case, the light having the second wavelength L2 is received by both the first light receiving element 42 and the second light receiving element 44, and the light having the first wavelength L1 is received only by the first light receiving element 42. That is, according to the optical apparatus 14 of the present embodiment, there is an effect that it is possible to identify whether each of the illumination points P1 and P2 is a glossy surface or a rough surface.

According to the present embodiment, it is possible to provide the optical apparatus 14, the optical inspection system 10, the method for imaging the object P, and the non-transitory storage medium storing the imaging program for imaging the object P, which are configured to image the relatively moving object P not only from a facing position but also obliquely.

### (Modification 1)

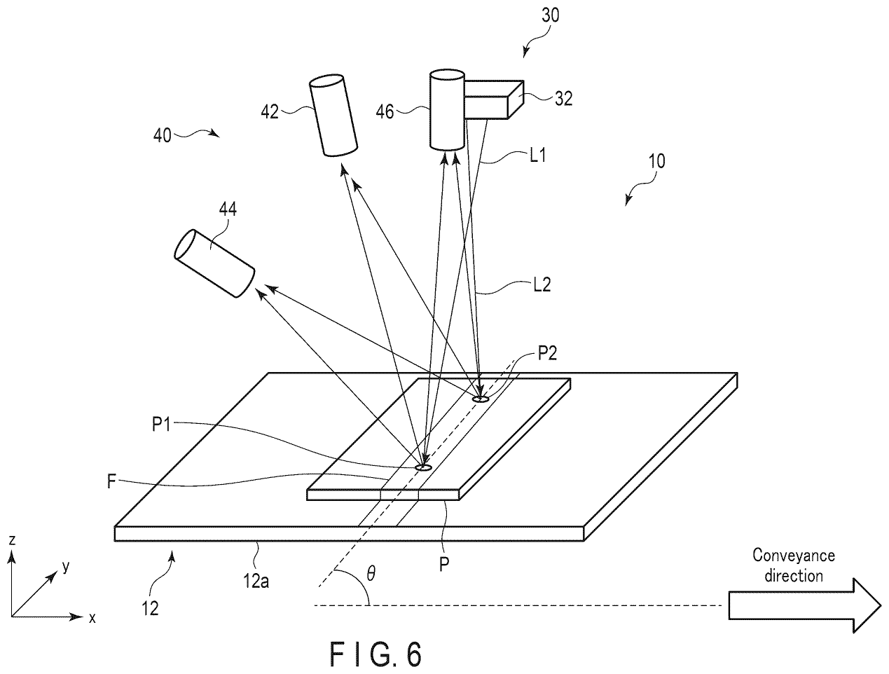

An xyz orthogonal coordinate system is taken as illustrated in FIG. 6 following FIG. 1.

In the light receiving portion 40 of the optical apparatus 14 according to the present embodiment, only the first light receiving element 42 and the second light receiving element 44 are used, but as illustrated in FIG. 6, a plurality of light receiving elements including the first light receiving element 42, the second light receiving element 44, and a third light receiving element 46 may be used such that the light receiving elements are arranged in different spaces. These light receiving elements 42, 44, and 46 are arranged so as to have different spatial positions. The direction of a line segment connecting the first light receiving element 42 and the second light receiving element 44 and the direction of a line segment connecting the first light receiving element 42 and the third light receiving element 46 are different from each other. In this case, an angular distribution of a BRDF corresponding to a wavelength at each of the illumination points P1 and P2 and an appropriate point between the illumination points P1 and P2 can be acquired in more detail. Therefore, there is an effect that more detailed information of the object P can be acquired. According to the present embodiment, even in a case where a BRDF of a minute defect has anisotropy and the angle changes only in a cross section where the BRDF of the minute defect is present with respect to a standard surface, the direction of the line segment connecting the first light receiving element 42 and the second light receiving element 44 and the direction of the line segment connecting the first light receiving element 42 and the third light receiving element 46 are different from each other, and thus, it is possible to detect a change in the BRDF caused by the presence or absence of the minute defect.

As an example, the third light receiving element 46 may be disposed on the downstream side of the first light receiving element 42 along the conveyance direction (x-axis direction) immediately above the line segment connecting the illumination points P1 and P2.

### (Modification 2)

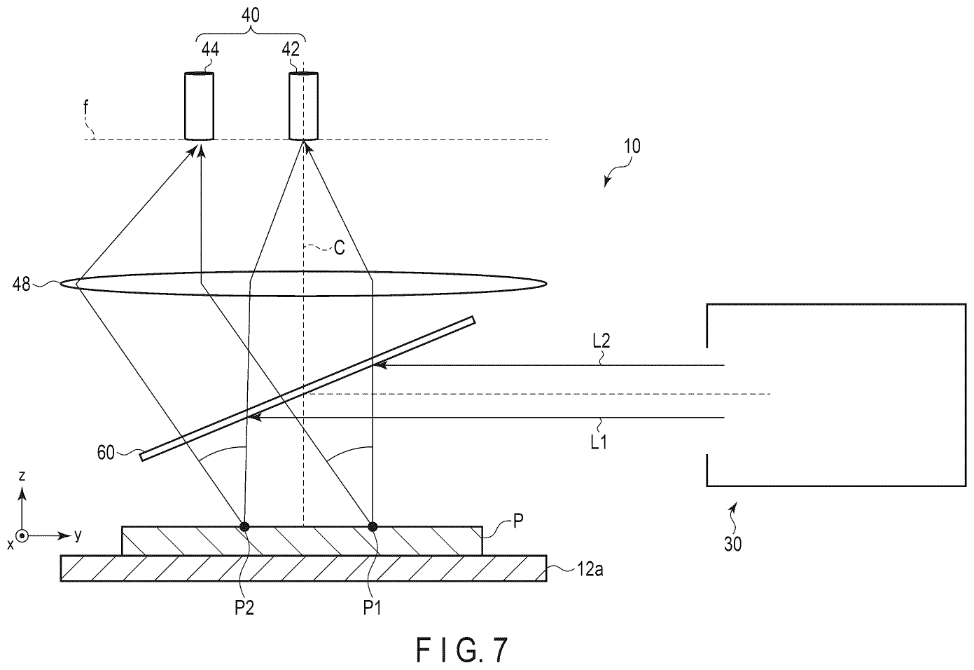

Hereinafter, an optical apparatus 14 according to Modification 2 of the present embodiment will be described with reference to FIG. 7.

FIG. 7 is a schematic cross-sectional view of an optical inspection system 10 according to Modification 2 as viewed from the downstream side of the irradiation field F. An xyz orthogonal coordinate system is taken as illustrated in FIG. 7 following FIG. 1. The cross-sectional view illustrated in FIG. 7 is orthogonal to the conveyance direction of the conveyance portion 12a.

The optical apparatus 14 according to the present modification includes an illumination portion 30, a light receiving portion 40, and a beam splitter 60. Although not described in detail, the illumination portion 30 in FIG. 7 can emit, toward the beam splitter 60, light having the first wavelength L1 and the second wavelength L2 as parallel light.

The illumination portion 30 emits light (or light beams) having the first wavelength L1 and the second wavelength L2. The light L1 and L2 emitted from the illumination portion 30 is reflected by the beam splitter 60 and reaches the object P. Points at which the light having the first wavelength L1 and the light having the second wavelength L2 reach the object P are referred to as a first illumination point P1 and a second illumination point P2, respectively. In the present modification, the light source 32 of the illumination portion 30 emits a parallel light beam group. Therefore, the light having the first wavelength L1 and the light having the second wavelength L2 are parallel to each other.

Similarly to the first light receiving element 42 described in the first embodiment, the first light receiving element 42 and the second light receiving element 44 of the light receiving portion 40 may be any elements as long as the first light receiving element 42 and the second light receiving element 44 distinctively receive the light having the first wavelength L1 and the light having the second wavelength L2 and convert the received light into independent light reception signals.

Furthermore, the light receiving portion 40 includes an imaging optical element 48. The imaging optical element 48 is, for example, an imaging lens. In FIG. 7, the imaging lens is schematically represented by one lens, but may be an assembled lens including a plurality of lenses. Alternatively, the imaging optical element 48 may be a concave mirror, a convex mirror, or a combination thereof. That is, the imaging optical element 48 may be any optical element as long as it has a function of collecting a light beam group emitted from one point of the object P, that is, an object point, at a conjugate image point. The fact that the light beam group emitted from the object point on the surface of the object P is collected (focused) at the image point by the imaging optical element 48 is referred to as imaging. Alternatively, the object point is also referred to as being transferred to an image point (conjugate point of the object point). A set surface of conjugate points to which a light beam group emitted from a sufficiently far object point is transferred by the imaging optical element 48 is referred to as a focal plane f of the imaging optical element 48. In addition, It is assumed that a line perpendicular to the focal plane f and passing through the center of the imaging optical element 48 is an optical axis C. In this case, a conjugate image point of an object point that is sufficiently far on the optical axis C is referred to as a focal point. In the present embodiment, the imaging optical element 48 may be simply referred to as a lens.

Each of the first light receiving element 42 and the second light receiving element 44 is disposed on the focal plane f of the imaging optical element 48. In the present modification, the first light receiving element 42 is disposed on the optical axis C immediately above the line segment connecting the first illumination point P1 and the second illumination point P2.

The line segment connecting the first illumination point P1 and the second illumination point P2 is orthogonal to the line along the conveyance direction of the conveyance portion 12a of the conveyance apparatus 12. That is, the line segment connecting the first illumination point P1 and the second illumination point P2 is not parallel to the line along the conveyance direction of the conveyance portion 12a of the conveyance apparatus 12. In other words, an angle θ formed by the line segment connecting the two illumination points P1 and P2 and the line along the conveyance direction is greater than 0° and less than 180°. In the present embodiment, the angle θ formed by the line segment connecting the two illumination points P1 and P2 and the line along the conveyance direction is 90°. It is assumed that the longitudinal direction of the irradiation field F is along the line connecting the two illumination points P1 and P2. As a result, the area where the irradiation field F passes through the object P during conveyance can be maximized. On the other hand, as the longitudinal direction of the irradiation field F is aligned with respect to the conveyance direction, the area where the irradiation field passes through the object P during conveyance becomes is smaller. That is, the region of the irradiation field F passing through the object P can be increased by making the irradiation field F and the conveyance direction orthogonal to each other. As a result, there is an effect that the range in which imaging can be performed is increased.

An operation of the optical inspection system 10 according to the present modification described above will be described.

The processing portion 50 controls the illumination portion 30 to emit light toward the conveyance portion 12a of the conveyance apparatus 12 via the beam splitter 60. A region irradiated with light from the light source 32 of the illumination portion 30 is referred to as an irradiation field F. The object P conveyed by the conveyance portion 12a of the conveyance apparatus 12 is illuminated with light from the light source 32 of the illumination portion 30. Light having the first wavelength L1 and the second wavelength L2 is emitted from the light source 32 of the illumination portion 30, and is reflected by or transmitted through the surface of the object P.

A point at which the light having the first wavelength L1 reaches the object P is referred to as a first illumination point P1, and a point at which the light having the second wavelength L2 reaches the object P is referred to as a second illumination point P2. The light source 32 of the illumination portion 30 emits light such that the first illumination point P1 and the second illumination point P2 are different points. The light that passed through (in the present modification, reflected by) the first illumination point P1 and the second illumination point P2 is received by the first light receiving element 42, and is acquired as independent light reception signals for each of the wavelengths L1 and L2. The intensities of the received light are indicators representing the magnitude of the reflectance at the first illumination point P1 and the second illumination point P2. That is, as the reflectance at each of the illumination points P1 and P2 is higher, the intensity of the received light increases accordingly. The reflectance is an important characteristic of the object P, and acquiring a distribution of the reflectance of the object P or the distribution of an indicator of the reflectance of the object P is called image capturing or imaging. As described above, the processing portion 50 can perform imaging on the first illumination point P1 and the second illumination point P2 using the first light receiving element 42. Similarly, light that passed through (in the present modification, reflected by) the first illumination point P1 and the second illumination point P2 is received by the second light receiving element 44, and is acquired as independent light reception signals for each of the wavelengths L1 and L2. Then, the processing portion 50 can perform imaging on the first illumination point P1 and the second illumination point P2 using the second light receiving element 44.

According to the present modification, light in two different reflection directions from the first illumination point P1 can be received by the first light receiving element 42 and the second light receiving element 44. In addition, the first light receiving element 42 and the second light receiving element 44 can receive light from the second illumination point P2 in two different reflection directions similarly to light that can be received from the first illumination point P1. It is known that the BRDF from each of the points P1 and P2 of the object P reflects physical property information of the object P. Then, by acquiring dependence of the BRDFs on reflection angles, more detailed physical property information can be acquired. In the present modification, light intensities for two reflection angles in the BRDFs from the first illumination point P1 and the second illumination point P2 can be simultaneously acquired. Then, these BRDFs can be compared. By using the optical apparatus 14, there is an effect that more detailed physical property information of the object P can be acquired.

For example, it is assumed that the object P is a flat surface and a smooth glossy surface. Then, it is assumed that no defect is present at the first illumination point P1 and a defect is present at the second illumination point P2. In general, the BRDF of the glossy surface causes specular reflection. In addition, the angular distribution of the BRDF at the point where the defect is present is generally widened. Therefore, specular reflection occurs at the first illumination point P1 and specularly reflected light is incident on the first light receiving element 42. On the other hand, since reflection with a wide angular distribution occurs at the second illumination point P2, the reflected light is received by both the first light receiving element 42 and the second light receiving element 44. In this case, the light having the second wavelength L2 is received by both the first light receiving element 42 and the second light receiving element 44, and the light having the first wavelength L1 is received only by the first light receiving element 42, or the reception intensity in a case where the light having the first wavelength L1 is received by the second light receiving element 44 is sufficiently lower than the reception intensity of the second wavelength L2. That is, according to the present modification, the processing portion 50 acquires the reception intensities of the wavelengths L1 and L2 of the first light receiving element 42 and the second light receiving element 44, so that there is an effect that it is possible to detect that the defect is present at the second illumination point P2. Therefore, the processing portion 50 can acquire object information regarding the first illumination point P1 of the object P by acquiring the reception intensities of the wavelengths L1 and L2 of the first light receiving element 42 and the second light receiving element 44.

Note that, in FIG. 7, parallel light from the light source 32 of the illumination portion 30 is drawn so that the object P is vertically irradiated by the beam splitter 60. That is, the parallel light was drawn so that the parallel light is emitted perpendicularly to the flat surface of the object P. For example, the object P may be obliquely irradiated with parallel light from the light source 32 of the illumination portion 30 from the downstream side to the upstream side or from the upstream side to the downstream side along the conveyance direction by the beam splitter 60, and reflected light from the object P may be received by the light receiving portion 40 including the imaging lens 48.

According to the present modification, the processing portion 50 performs imaging based on the light reception signals in the light receiving portion 40. In this case, there is an effect that the object P which is a planar subject can be imaged not only directly above (facing position) but also obliquely. In the present modification, since the first light receiving element 42 and the second light receiving element 44 are used, there is an effect that the processing portion 50 can perform imaging from two different angular directions at the same time.

### Third Embodiment

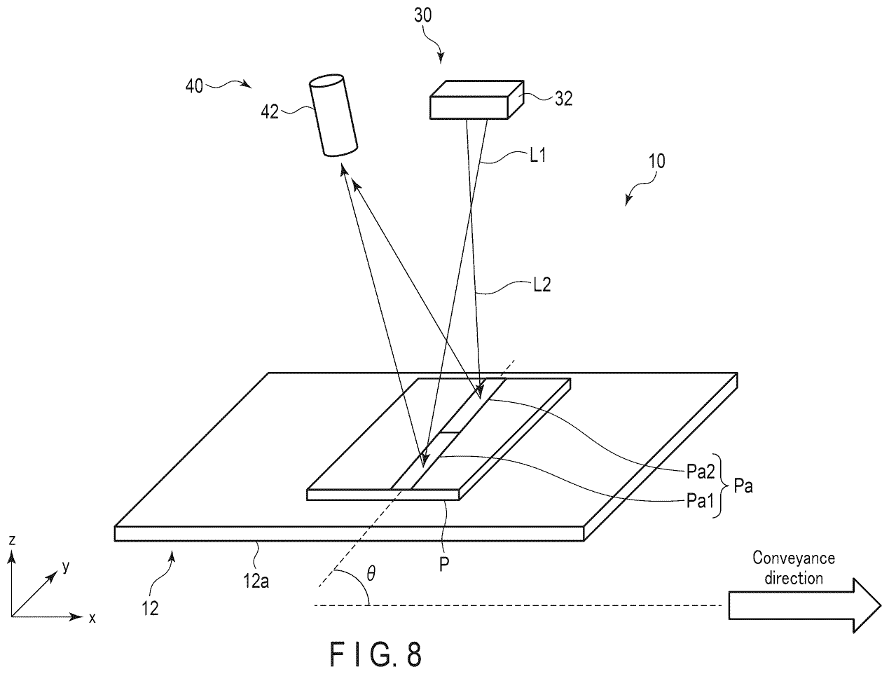

Hereinafter, an optical inspection system 10 according to the present embodiment will be described with reference to FIGS. 8 to 10.

FIG. 8 is a schematic perspective view of the optical inspection system 10 according to the present embodiment. An xyz orthogonal coordinate system is taken as illustrated in FIG. 8 following FIG. 1.

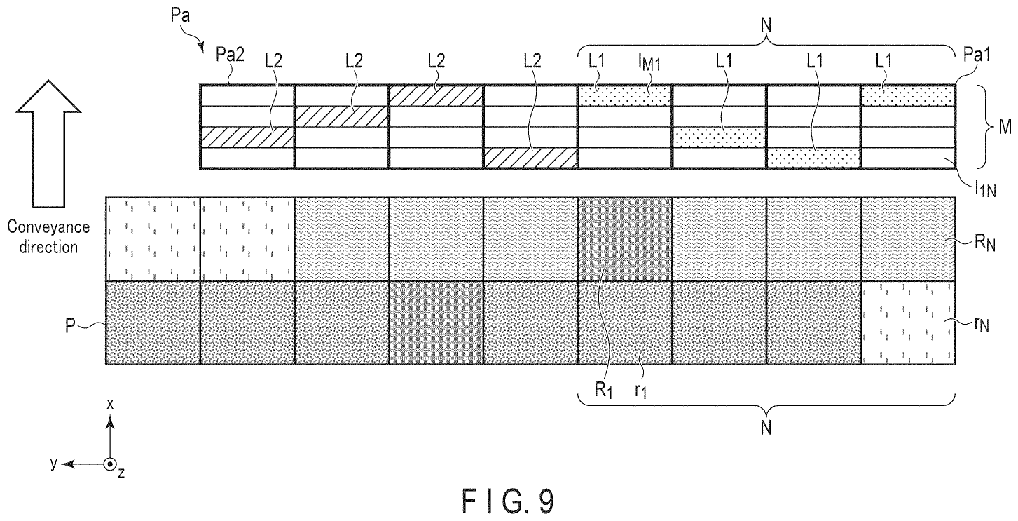

FIG. 9 illustrates a schematic top view illustrating the first wavelength L1 and the second wavelength L2 from the light source 32 of the illumination portion 30 of the optical inspection system 10 according to the present embodiment, and the object P conveyed on the conveyance portion 12a of the conveyance apparatus 12. The top view illustrated in FIG. 9 is a plane parallel to the conveyance direction. In the example illustrated in FIG. 9, the object P indicates a position immediately before the object P is illuminated with pattern light Pa. An xyz orthogonal coordinate system is taken as illustrated in FIG. 9 following FIG. 8.

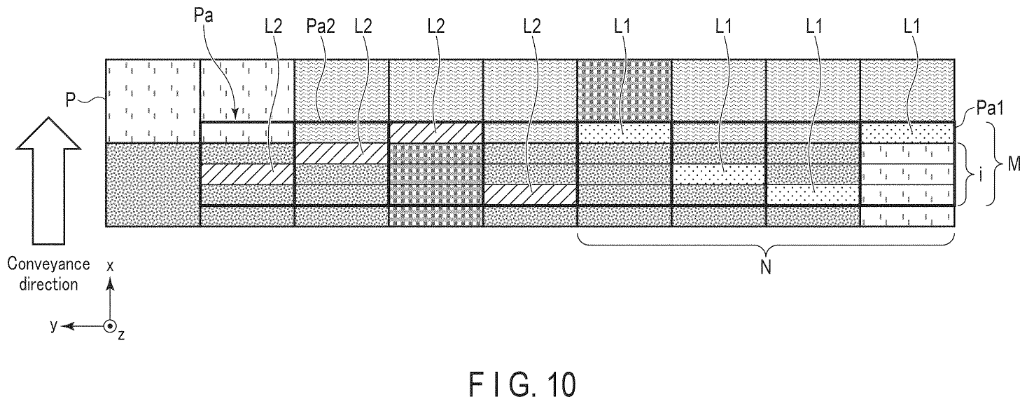

FIG. 10 is a schematic view illustrating a state in which the object P is illuminated with pattern light after an appropriate time elapsed from the state illustrated in FIG. 9. The top view illustrated in FIG. 10 is a plane parallel to the conveyance direction. An xyz orthogonal coordinate system is taken as illustrated in FIG. 10 following FIGS. 8 and 9.

As illustrated in FIG. 8, the light receiving portion 40 according to the present embodiment includes a first light receiving element 42.

The light source 32 of the illumination portion 30 includes, for example, a color projector (projection apparatus). The color projector may be a digital light processing (DLP) system including a digital mirror device (DMD), an LCD system including a liquid crystal display (LCD), a liquid crystal on silicon (LCOS) system, or the like. The light source 32 of the illumination portion 30 may be an LED or a laser. Light having the first wavelength L1 and light having the second wavelength L2 are emitted from the light source 32 of the illumination portion 30, and a projection pattern Pa is formed by the light having the first wavelength L1 and the light having the second wavelength L2.

As illustrated in FIGS. 8 to 10, the optical apparatus 14 forms a first projection pattern Pa1 of M×N projection pixels by the light having the first wavelength L1 from the light source 32 of the illumination portion 30. As illustrated in FIGS. 9 and 10, the number of projection pixels in the conveyance direction is M, and the number of projection pixels in the direction orthogonal to the conveyance direction is N. It is assumed that the aspect ratio (pixel size of a projection image) of each projection pixel projected by the light source (projection apparatus) 32 of the illumination portion 30 is smaller in the conveyance direction than that in the direction orthogonal to the conveyance direction. This is referred to as the first projection pattern Pa1. The first projection pattern Pa1 may be any pattern, but is assumed to be a random pattern here.

Similarly, the optical apparatus 14 forms a second projection pattern Pa2 of M×N projection pixels by the light having the second wavelength L2 from the light source 32 of the illumination portion 30. This is referred to as the second projection pattern Pa2. It is assumed that the aspect ratio (pixel size of a projection image) of each projection pixel projected by the light source (projection apparatus) 32 of the illumination portion 30 is smaller in the conveyance direction than that in the direction orthogonal to the conveyance direction. The second projection pattern Pa2 may be any pattern, but is assumed to be a random pattern here. M and N are integers, and M is greater than or equal to N (M≥N). In the present embodiment, M and N are the same (equal).

As illustrated in FIGS. 9 and 10, the processing portion 50 acquires light reception signals of the light having the first wavelength L1 and the second wavelength L2 every time the object P is conveyed by the conveyance portion 12a of the conveyance apparatus 12 and the first light receiving element 42 of the light receiving portion 40 by a projection pixel size (1/M) in the conveyance direction. The light reception signal of the light having the first wavelength L1 is blue light (B).

It is assumed that the region of the object P which passes through the first projection pattern Pa1 by being conveyed by the conveyance portion 12a can be imaged with the number of N pixels in the direction orthogonal to the conveyance direction. Then, it is assumed that imaging can be performed with pixels having the same size with respect to the conveyance direction. That is, it is assumed that the object P is constituted by uniform cell regions. Then, it is assumed that one side of each cell is equal to the projection pixel size of the first projection pattern Pa1 in the direction orthogonal to the conveyance direction.

The illumination portion 30 can use the projection apparatus as the light source 32 to set the light having the first wavelength L1 and the light having the second wavelength L2 to light at different irradiation positions.

An operation of the optical inspection system 10 according to the embodiment described above will be described.

FIG. 10 illustrates a top view of the present embodiment. FIG. 10 illustrates a state in which the object P is conveyed in the conveyance direction when a little time passed from the time in FIG. 9.

In the first projection pattern Pa1 by the light having the first wavelength L1, the total number of projection pixels is M×N. Here, each projection pixel value is I, a number in the conveyance direction is i, a number in the direction orthogonal to the conveyance direction is j, and Iij is added. That is, the received light intensity obtained by the first light receiving element 40 of the light receiving portion 40 when the first projection pattern Pa1 by the light having the first wavelength L1 is projected on the object P is defined as Iij.

Furthermore, among pixels of the object P passing through the first projection pattern Pa1, a pixel in an upper row in FIG. 9 is set as R, the number i in the conveyance direction is added to R, and the pixel is set as Ri. Similarly, a pixel in a lower row in FIG. 9 is set as ri. A light reception signal by the first light receiving element 42 when the pixel ri at a lower stage of the object P reaches the first stage (first/Mth stage) of the first projection pattern Pa1 is set to B1. Similarly, a light reception signal by the first light receiving element 42 when the pixel ri at the lower stage of the object P reaches the ith stage (ith/Mth stage) of the first projection pattern Pa1 is set to Bi. Here, it should be noted that M is greater than or equal to N. In this case, the following equation holds for i=1 to N.

$$( {\sum }_{α = 1}^{i} {I}_{α 1} ) {r}_{1} + ⋯ + ( {\sum }_{α = 1}^{i} {I}_{α N} ) {r}_{N} = {B}_{i} - ( {\sum }_{α = i + 1}^{M} {I}_{α 1} ) {R}_{1} - ⋯ - ( {\sum }_{α = i + 1}^{M} {I}_{α1} ) {R}_{N} \qquad ( 1 )$$

This Equation (1) can be regarded as N simultaneous equations. On the other hand, in a case where the pixel Ri in the upper row in FIG. 9 among the pixels of the object P is known, an unknown parameter is ri, and the number of unknowns is N. Therefore, the processing portion 50 can find a solution to Equation (1). Then, as the object P is conveyed, the processing portion 50 can acquire a pixel value of the object P passing through the projection pattern Pa by the light having the first wavelength L1 by inductively using Equation (1). That is, there is an effect that the processing portion 50 can image the object P passing through the region of the first projection pattern Pa1.

That is, when the pixels (reflectances) R1, . . . , and RN of the object P pass through the projection pixel values I11, . . . , and I1N to IN1, . . . , and INN of the first projection pattern Pa1, the processing portion 50 first determines the reflectances R1, . . . , and RN serving as references based on the light reception signals by the first light receiving element 42 of the light receiving portion 40. Thereafter, when the pixels (reflectances) r1, . . . , rN of the object P pass through the projection pixel values I11, . . . , I1N to IN1, . . . , INN of the first projection pattern Pa1, the processing portion 50 determines the reflectances r1, . . . , rN of the second row of the object P based on the light reception signals by the first light receiving element 42 of the light receiving portion 40 and the reflectances R1, . . . , RN serving as the references. That is, when the first projection pattern Pa1 is projected on the object P, the processing portion 50 determines a reflectance of the second row of the object P using a reflectance of the first row of the object P. Similarly, the processing portion 50 recursively determines a reflectance for the remaining pixels (reflectance) of the object P.

That is, when passing the object P under the first projection pattern Pa, the processing portion 50 acquires light reception signals in increments of 1/M, and thereafter, can obtain the pixel value in each pixel of the object P by inductive calculation. Therefore, the processing portion 50 can image the object P based on the pixel value in each pixel of the object P.

The same applies to the second projection pattern Pa2 formed by the light having the second wavelength L2. The light having the first wavelength L1 and the light having the second wavelength L2 can be simultaneously and independently acquired by the first light receiving element 42. Therefore, there is an effect that the object P being conveyed can be imaged over the entire projection region by the illumination portion 30. That is, there is an effect that a wide range can be imaged by simultaneously using the light having the second wavelength L2 as well as using only the first wavelength L1. For example, in a case where the third wavelength L3 is used, the projection pixel size of the projection pattern Pa in the direction (N) orthogonal to the conveyance direction can be reduced, and more detailed imaging can be performed.

It is assumed that the projection pixel size of the projection pattern Pa is smaller in the conveyance direction (M) than that in the direction (N) orthogonal to the conveyance direction. As a result, there is an effect that the object P that passed through the projection pattern Pa using Equation (1) can be imaged even with a short conveyance distance, according to the optical inspection system 10.

According to the present embodiment, it is possible to provide the optical apparatus 14, the optical inspection system 10, the method for imaging the object P, and the non-transitory storage medium storing the imaging program for imaging the object P, which are configured to image the relatively moving object P not only from a facing position but also obliquely.

### (Modifications)

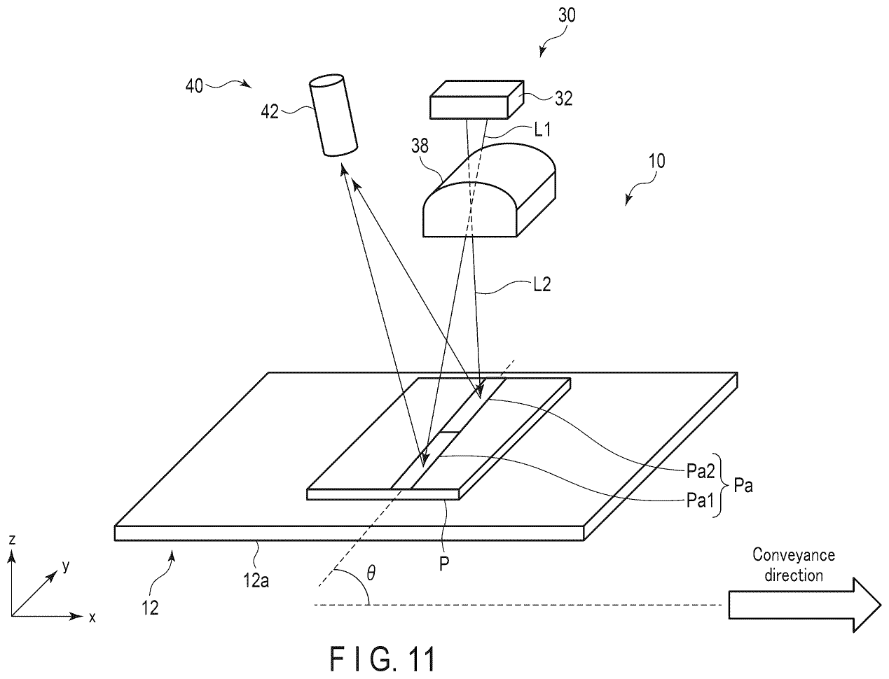

As illustrated in FIG. 11, the projection pattern Pa by the light source 32 of the illumination portion 30 may be focused using a cylindrical lens 38, and the size (M) of the irradiation field in one direction (for example, the conveyance direction) may be further reduced. As a result, there is an effect that the object P that passed through the projection pattern Pa using Equation (1) can be imaged even with a short conveyance distance.

According to at least one of the embodiments described above, it is possible to provide the optical apparatus 14, the optical inspection system 10, the method for imaging the object P, and the non-transitory storage medium storing the imaging program for imaging the object P, which are configured to image the relatively moving object P not only from the facing position but also obliquely.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical apparatus comprising:
an illumination portion that is configured to illuminate an object relatively moving in a predetermined direction with light,
the illumination portion being configured to illuminate a first illumination point of the object with light having a first wavelength and illuminate a second illumination point different from the first illumination point of the object with light having a second wavelength different from the first wavelength, and
a line segment connecting the first illumination point and the second illumination point intersecting the predetermined direction;
a light receiving portion including a first light receiving element that is configured to move relative to the object while maintaining a positional relationship with the illumination portion and that is configured to receive light that passed through the first illumination point of the object and light that passed through the second illumination point,
the first light receiving element being configured to distinctively and independently receive the first wavelength and the second wavelength; and
a processor that is configured to image the object by a light reception signal of the light that passed through the first illumination point and a light reception signal of the light that passed through the second illumination point.

2. The optical apparatus according to claim 1, wherein
the light receiving portion further includes a second light receiving element disposed so as to have a spatial position different from a spatial position of the first light receiving element,
the second light receiving element is configured to distinctively and independently receive the first wavelength and the second wavelength, and
the processor is configured to acquire object information regarding the first illumination point of the object by signals received by the first light receiving element and the second light receiving element.

3. The optical apparatus according to claim 2, further comprising:
an imaging optical element that allows light from the object to pass through the imaging optical element, and
at least the first light receiving element is disposed on a focal plane of the imaging optical element.

4. The optical apparatus according to claim 3, wherein
the second light receiving element is further disposed on the focal plane of the imaging optical element.

5. The optical apparatus according to claim 2, wherein
the light receiving portion further includes a third light receiving element disposed so as to have a spatial position different from the spatial positions of the first light receiving element and the second light receiving element,
a direction of a line segment connecting the first light receiving element and the second light receiving element is different from a direction of a line segment connecting the first light receiving element and the third light receiving element,
the third light receiving element is configured to distinctively and independently receive the first wavelength and the second wavelength, and
the processor is configured to acquire object information regarding the first illumination point of the object by signals received by the first light receiving element, the second light receiving element, and the third light receiving element.

6. The optical apparatus according to claim 1, wherein
the illumination portion uses a diffraction grating to set the light having the first wavelength and the light having the second wavelength to light at different irradiation positions.

7. The optical apparatus according to claim 1, wherein
the illumination portion uses a projection apparatus to set the light having the first wavelength and the light having the second wavelength to light at different irradiation positions.

8. The optical apparatus according to claim 7, wherein
a pixel size of a projection image projected by the projection apparatus is smaller in the predetermined direction than in a direction orthogonal to the predetermined direction, and
the processor is configured to image the object by the projection image and a signal obtained by the first light receiving element.

9. The optical apparatus according to claim 7, wherein
the illumination portion is configured to focus light on an irradiation field size in one direction using a cylindrical lens.

10. An optical inspection system comprising:
the optical apparatus according to claim 1; and
a conveyance apparatus including a conveyance portion that is configured to convey the object in the predetermined direction and that is configured to move relative to the illumination portion and the light receiving portion.

11. An object imaging method comprising:
illuminating a first illumination point of an object with light having a first wavelength from an illumination portion and illuminating a second illumination point different from the first illumination point of the object with light having a second wavelength different from the first wavelength from the illumination portion while maintaining a relative position of an optical apparatus including the illumination portion and a light receiving portion and moving the object in a predetermined direction relative to the illumination portion and the light receiving portion;
receiving light that passed through the first illumination point of the object and light that passed through the second illumination point by the light receiving portion including a first light receiving element configured to distinctively and independently receive the first wavelength and the second wavelength;
performing imaging of the object by a light reception signal of the light that passed through the first illumination point and a light reception signal of the light that passed through the second illumination point by the light receiving portion,
wherein a line segment connecting the first illumination point and the second illumination point intersects the predetermined direction.

12. A non-transitory storage medium storing an object imaging program for causing a computer to execute:
illuminating a first illumination point of an object with light having a first wavelength from an illumination portion and illuminating a second illumination point different from the first illumination point of the object with light having a second wavelength different from the first wavelength from the illumination portion while maintaining a relative position of an optical apparatus including the illumination portion and a light receiving portion and moving the object in a predetermined direction relative to the illumination portion and the light receiving portion, a line segment connecting the first illumination point and the second illumination point intersecting the predetermined direction; and
receiving light that passed through the first illumination point of the object and light that passed through the second illumination point by the light receiving portion including a first light receiving element configured to distinctively and independently receive the first wavelength and the second wavelength; and
performing imaging of the object by a light reception signal of the light that passed through the first illumination point and a light reception signal of the light that passed through the second illumination point by the light receiving portion.
